(19) United States
(12) Patent Application Publication
(10) Pub. No.: US 2013/0191215 A1
(43) Pub. Date: Jul. 25, 2013

(54) LOCATION-BASED APPLICATION POP UP

(71) Applicant: Michael Metcalf, San Francisco, CA (US)

(72) Inventor: Michael Metcalf, San Francisco, CA (US)

(73) Assignee: YAHOO! INC., Sunnyvale, CA (US)

(21) Appl. No.: 13/355,347

(22) Filed: Jan. 20, 2012

(51) Int. Cl. G06Q 30/02

(52) U.S. Cl. 705/14.58

(57) ABSTRACT

In one embodiment, a plurality of bids on a location are obtained, wherein each of the plurality of bids pertains to one of a plurality of applications. A pre-defined number of the plurality of applications are selected based, at least in part, upon the plurality of bids, such that a set of one or more of the plurality of applications is identified, wherein each of the plurality of bids pertains to an exclusive right for the set of one or more applications or one or more advertisements pertaining to the set of one or more applications to be provided to users present at the location. The set of one or more of the plurality of applications are associated with the location.

### BACKGROUND OF THE INVENTION

The disclosed embodiments relate generally to methods and apparatus for providing applications or advertisements associated therewith to users based, at least in part, upon locations associated with the applications.

Geo-targeting is the method of determining the geographical location of a website visitor and delivering different content to that visitor based on his or her location, such as country region/state, city, zip code, organization, Internet Protocol (IP) address, Internet Service Provider (ISP), or other criteria. A common usage of geo-targeting is found in online advertising. Therefore, geo-targeting delivers content to visitors based upon the location of the searcher.

### SUMMARY OF THE INVENTION

The disclosed embodiments enable pop-applications to be provided to users. Through pop-up applications, applications or advertisements associated therewith may be provided to users. This may be accomplished based, at least in part, upon locations associated with the applications.

In accordance with one embodiment, a location may be identified, where the location is associated with a set of one or more applications. A set of one or more users that are present at the location may be ascertained. The set of one or more applications or one or more advertisements may be provided to the set of one or more users, where each of the advertisements pertains to a corresponding one of the set of one or more applications.

In accordance with another embodiment, a location at which a user is present may be identified. A set of one or more applications associated with the location may be ascertained. The set of one or more applications or one or more advertisements may be provided to the user, where each of the advertisements pertains to a corresponding one of the set of one or more applications.

In accordance with yet another embodiment, a plurality of bids for a location may be obtained, wherein each of the plurality of bids pertains to one of a plurality of applications. A pre-defined number of the plurality of applications may be selected based, at least in part, upon the plurality of bids, such that a set of one or more of the plurality of applications is identified, wherein each of the plurality of bids pertains to an exclusive right for the set of one or more applications or one or more advertisements pertaining to the set of one or more applications to be provided to users present at the location. The set of one or more of the plurality of applications may be associated with the location.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2 is a process flow diagram illustrating an example method of providing a location-based application pop-up in accordance with various embodiments.

FIG. 3 is a process flow diagram illustrating an example method of providing a location-based application pop-up in accordance with various embodiments.

FIG. 4 is a process flow diagram illustrating an example method of auctioning locations in accordance with various embodiments.

FIG. 5 is a schematic diagram illustrating an example embodiment of a network in which various embodiments may be implemented.

FIG. 6 is a schematic diagram illustrating an example client device in which various embodiments may be implemented.

FIG. 7 is a schematic diagram illustrating an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Geo-targeting is typically used to select, create, transmit, and/or otherwise provide advertisements to website users based upon their current location. The current location of website users may be determined based upon location data that the users have explicitly and/or implicitly provided to the website. More particularly, the location data may be obtained from account data provided by the users during registration or as a result of updating the account data after registration has been completed. For example, the account data may include a registration zip code, home location (e.g., address or portion thereof), and/or work location (e.g., address or portion thereof). Therefore, the account data for a particular website user may identify one or more locations of the website user. The current location of the website user may also be identified based upon signals explicitly transmitted by the user or implicit signals. Examples of implicit signals include an IP address of the website user, wifi triangulation, or Global Positioning System (GPS) location, which may be used to infer a current location, a home location, or a work location. As another example, the user's location may be implied through cell tower triangulation. A user may explicitly check in to a location via the use of a check in application, which may be accessed via a website and/or installed on a device such as a mobile device.

Geo-targeting typically focuses on location data explicitly or implicitly indicating the current location of the user. The assumption is that the user will likely take shopping action near the Normal Geographic Areas where the user spends the majority of their time. Normal Geographic Areas may include the user's home, work, school, etc. Furthermore, as will be described in further detail below, the disclosed embodiments may consider user behavior outside their Normal Geographic Area (NGA). Areas outside of the NGA may include a parent's home, vacation locations, business travel, etc.

In accordance with the disclosed embodiments, software applications may be provided or otherwise advertised to a user based, at least in part, upon locations associated with (e.g., mapped to) the applications and the user's location. Mappings between locations and applications may be generated as a result of an auctioning process, as will be described in further detail below. Advertisements may pertain to applications that may be downloaded to and/or launched via a mobile device. Alternatively, the system may provide (e.g., transmit, download and/or launch) applications to consumer devices rather than merely provide advertisements.

In accordance with various embodiments, an application or an advertisement pertaining to the application may be provided to a user in the form of a pop-up window. The pop-up window may present an image representative of the application via a graphical user interface of a device such as a mobile device when the user enters a particular location associated with the application. The pop-up window may merely include an advertisement (e.g., notification or image representative of an application). Alternatively, the pop-up window may be presented in association with the downloading and/or launching of the application represented in the pop-up window.

Example System

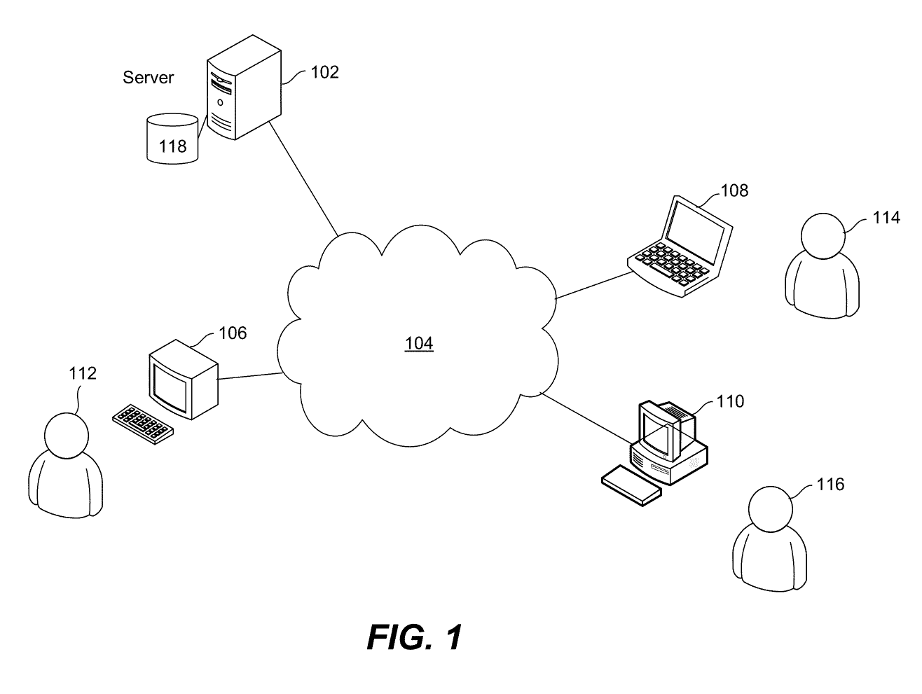

FIG. 1 is a diagram illustrating an example system in which embodiments of the invention may be implemented. As shown in FIG. 1, the system may include one or more servers 102 associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may maintain public user profiles, interact with other members of the web site, upload files (e.g., photographs, videos), etc.

In this example, the server(s) 102 may obtain or otherwise receive data (e.g., account data and/or user profile) and/or requests (e.g., search requests) via the Internet 104 from one or more computers 106, 108, 110 in association with corresponding entities 112, 114, 116, respectively. For example, each of the entities 112, 114, 116 may be an individual, a group of individuals (e.g., group, business or company), or other entity such as a web site. However, in order to simplify the description, the disclosed embodiments will be described with reference to individuals that are users of the web site.

The server(s) 102 may have access to one or more user logs 118 (e.g., user databases) into which user information is retained. This user information or a portion thereof may be referred to as a user profile. More particularly, the user profile may include public information that is available in a public profile and/or private information. The user logs 118 may be retained in one or more memories that are coupled to the server 102.

The user information retained in the user logs 118 may include personal information such as demographic information (e.g., age and/or gender) and/or geographic information (e.g., residence address, work address, and/or zip code). In addition, each time a user performs online activities such as clicking on an advertisement or purchasing goods or services, information regarding such activity or activities may be retained as user data in the user logs 118. For instance, the user data that is retained in the user logs 118 may indicate the identity of web sites visited, identity of ads that have been selected (e.g., clicked on) and/or a timestamp. Moreover, where the online publisher supports a search engine (e.g., via the server 102 or a separate search server), information associated with a search query, such as search term(s) of the search query, information indicating characteristics of search results that have been selected (e.g., clicked on) by the user, and/or associated timestamp may also be retained in the user logs 118. A user may be identified in the user logs 118 by a user ID (e.g., user account ID), information in a user cookie, etc.

An online publisher (i.e., web publisher) will generally be responsible for delivering multiple advertisements via the Internet (or other communication media such as email, text message, or digital television). A contract agreement associated with a particular advertisement may specify a minimum number of page views (i.e., impressions) to be delivered within a particular period of time. The web publisher is therefore responsible for providing the requested number of impressions for each advertisement.

In accordance with various embodiments, the system may store a plurality of applications and/or corresponding advertisements. For example, advertisements associated with applications may include images representative of the applications. Each of the applications and/or advertisements may be associated with a corresponding set of one or more locations. For example, an interactive map application may be associated with the San Francisco Airport.

In accordance with various embodiments, an online publisher agrees to provide applications or advertisements associated therewith to users present at locations associated with the applications. For example, an online publisher may provide an interactive map application to users present at the San Francisco Airport. Such application/advertisement-location associations may be generated in response to auctioning of locations to advertisers or application developers/owners, as will be described in further detail below.

An advertisement may include content pertaining to a product or service (e.g., application), which may be delivered via the Internet, email, text message, or digital television. The content typically includes text. However, it is important to note that an advertisement may include text, one or more images, video, and/or audio. An advertisement may also include one or more hypertext links, enabling a user to proceed with the purchase of a particular product or service.

The disclosed embodiments enable applications and/or advertisements associated therewith to be identified, selected, generated, transmitted, and/or otherwise provided to users based, at least in part, upon locations associated with the applications. More particularly, the server(s) 102 may provide applications and/or advertisements associated therewith to the users present at various locations via the web site (e.g., via display on a web page of the web site), via electronic mail, Short Message Service (SMS), via a mobile device (e.g., text message), or via another medium such as digital television, which may be connected to the Internet. For example, an application or an advertisement pertaining to the application may be provided to the user in the form of a pop-up window.

Where an application or advertisement associated therewith is provided to a particular user, information pertaining to the application or advertisement (e.g., identifying a product or service advertised in the advertisement) may be stored in association with the user's account data. For example, information identifying an application may be stored in association with the user's account data. In addition, the server(s) 102 may automatically collect online (and/or real world) behavioral data for any of users 112, 114, 116 to determine whether the advertisement was successful. In other words, the server(s) 102 may determine whether the user purchased the product or service advertised in the advertisement. For example, the server(s) 102 may determine whether the application is subsequently downloaded or purchased. Data indicating whether the advertisement was successful may also be stored in association with the user's account data and/or the advertisement. Therefore, data indicating whether an application is accessed or purchased may also be stored in association with the user's account data and/or the application.

Advertising

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

Ad Networks/Exchanges

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

Ad Targeting

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Ad Serving

An “ad server” comprises a server that stores online advertisements for presentation to users. “Ad serving” refers to methods used to place online advertisements on websites, in applications, or other places where users are more likely to see them, such as during an online session or during computing platform use, for example.

Ad Analytics

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Example Embodiments

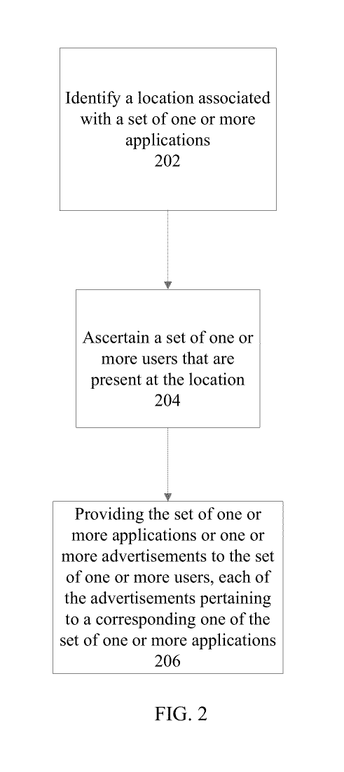

FIG. 2 is a process flow diagram illustrating an example method of providing a location-based application pop-up in accordance with various embodiments. The system may identify a location associated with a set of one or more applications at 202. For example, the system may maintain a list of applications for which application pop-ups (e.g., advertisements and/or applications) are to be provided. Each of these applications may be mapped to one or more locations. Therefore, the system may select one of the applications in the list and identify the corresponding location(s) associated with the application.

The system may ascertain a set of one or more users that are present at the location at 204. Presence of a user at a location may include presence for any length of time. For example, a user may simply pass through a location, but be considered present at the location for the period of time that the user travels through the location. Travel may include walking, driving, or other mode of transportation. The location may be a geographical area, a location identified by specific GPS coordinates, a business entity (e.g., airport or restaurant), an address, a building, etc. A geographical area may be defined by a street block, neighborhood (e.g., Times Square), city, state, an area defined by coordinates delineating the boundaries of the area, an area defined by boundaries selected on a map provided via a graphical user interface, etc.

The system may provide the set of one or more applications or one or more advertisements associated therewith to the set of one or more users at 206, where each of the advertisements pertains to a corresponding one of the set of one or more applications. More particularly, the set of applications or advertisements associated therewith may be provided to one of the set of users when the user enters or arrives at the location. Furthermore, the set of applications or advertisements associated therewith may be provided in response to ascertaining the set of users that are present at the location. Alternatively, the set of applications or advertisements associated therewith may be provided to one of the set of users within a pre-determined period of time from when the one of the set of users enters or arrives at the location (e.g., after the user enters or arrives at the location). The set of applications or advertisements associated therewith may be provided for a pre-defined period of time. Alternatively, the set of applications or advertisements associated therewith may be provided to a user during the entire time that the user is present at the location.

The examples described herein refer to a single location associated with an application. However, it is important to note that an application may have associated therewith more than one location. Therefore, the embodiments described herein may be performed for each location associated with an application.

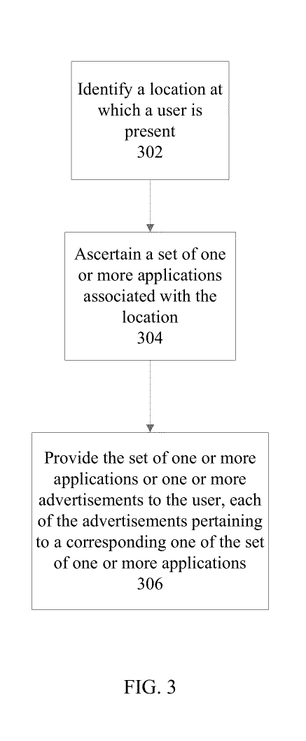

FIG. 3 is a process flow diagram illustrating an example method of providing a location-based application pop-up in accordance with various embodiments. The system may identify a location at which a user is present at 302. For example, the system may monitor the activities (e.g., location) of a particular user, and periodically identify the location at which the user is present. As another example, the system may monitor whether users are present at a particular location, and periodically identify users that are present at the location. In other words, the system may determine that a user is present at a particular location.

The system may then ascertain a set of one or more applications associated with the location at 304. For example, the system may maintain a list of applications for which advertisements and/or the corresponding applications are to be provided. Each of these applications may be mapped to one or more locations. Similarly, each of the locations may be mapped to a set of one or more applications. Therefore, the system may identify a mapping that maps the location to a set of one or more applications, and ascertain the set of one or more applications that correspond to the location from this mapping. The system may then provide the set of applications or one or more advertisements to the user at 306, where each of the advertisements pertains to a corresponding one of the set of one or more applications.

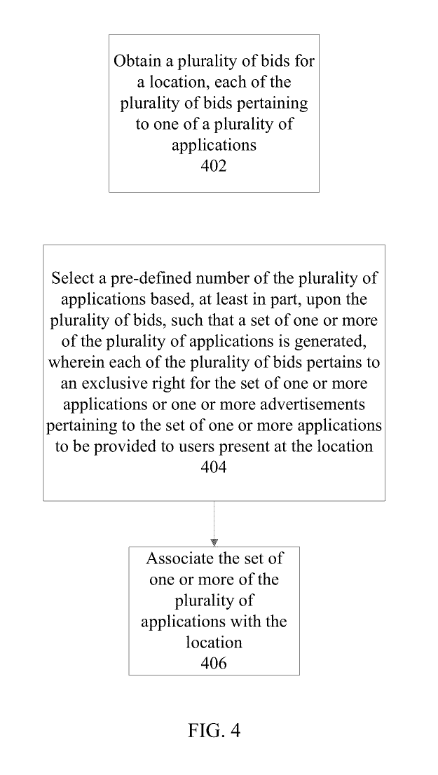

Mappings between applications and corresponding locations may be generated as a result of an auctioning process. FIG. 4 is a process flow diagram illustrating an example method of auctioning locations in accordance with various embodiments. The system may obtain a plurality of bids for a particular location at 402, where each of the plurality of bids pertains to one of a plurality of applications. The system may select a pre-defined number of the plurality of applications based, at least in part, upon the plurality of bids such that a set of one or more of the plurality of applications is identified (e.g., generated) at 404. Each of the plurality of bids may pertain to an exclusive right for the set of one or more applications or one or more advertisements pertaining to the set of one or more applications to be provided to users present at the location. Since the number of applications selected is limited, users entering the location may receive a limited number of application pop-ups. The system may associate the set of one or more of the plurality of applications with the location at 406. For example, the system may store information mapping the set of applications to the location. This mapping information may enable applications to be indexed by location, as well as enable locations to be indexed by application.

The embodiments described with reference to FIG. 4 refer to a set of applications associated with a location. However, it is important to note that an application may have associated therewith more than one location. In addition, the system may maintain mappings for a plurality of locations. Therefore, the embodiments described herein may be performed for each one of the plurality of locations.

The price that an advertiser or application developer/owner is charged for providing an application or associated advertisement may be based upon one or more factors. More particularly, the price may be based, at least in part, upon the number of applications in the set of applications that have an exclusive right to a particular location. For example, where the set of applications associated with a particular location includes a single application, the charge may be higher than where the set of applications includes a large number of applications. In addition, the price may be based, at least in part, on the number of users predicted to be at the particular location.

In accordance with various embodiments, a user may opt-in to the system for providing location-based application pop-ups. More particularly, as a result of opting-in, the system may track the location of the user, enabling the user to receive applications or advertisements associated therewith based, at least in part, upon the user's location. The user may receive various benefits as a result of opting in. For example, the user may receive monetary payment, discounts, or other services in return for the user opting in to the system.

Signals Indicating Current and Future User Location

User location(s) of a user may be identified based upon one or more signals (i.e., data). Each of the signals may be obtained from one or more data sources. Example signals will be described in further detail below.

The user's current location may be identified based upon traditional mechanisms such as IP address and/or GPS location. Other mechanisms for tracking a user's location include applications such as Glympse, which enables a user to share his or her location. In addition, the user's location may be ascertained based upon check-in information. More particularly, a user may choose to check in to a particular establishment or event via an application such as Foursquare, Messenger, or Bubbles. Such a check-in application may be implemented on a web site and/or a mobile device. Thus, the user's current location may be determined based upon the location of the establishment or event. More particularly, an event may be scheduled to occur at a particular location at an associated time (e.g., date, start time, length, and/or time period). For example, an event may be defined by an associated location and expected time that the event is to occur. Example events may include, but are not limited to, a baseball game, concert, etc.

In accordance with various embodiments, future user location(s) of each of a plurality of users may be predicted based upon one or more signals (e.g., data) obtained from one or more data sources. From this information, the system may predict the number of users likely to be present in each of a plurality of locations. Information indicating the predicted inventory (e.g., number of users) at each of the plurality of locations may be provided or made available to a bidding/auctioning process. For purposes of auctioning the locations, each of the locations may be priced based, at least in part, upon the number of users predicted to be present at the corresponding location and/or the number of applications to be associated with (and have an exclusive right to) the location. Examples of data that may be obtained and/or analyzed for use in predicting future user locations are described in further detail below.

The data that is obtained and/or analyzed may include one or more calendar entries of a user's electronic calendar. A calendar entry may include structured geographic information identifying a projected future location of the user, enabling the user's current location to be identified. For example, the structured geographic information may include a restaurant name and/or address, airport code(s), hotel reservation(s) (e.g., hotel name and/or address), car reservations, restaurant reservations, destination address(es), driving directions, and/or event(s) such as baseball games, concerts, etc. (e.g., identified event name and/or address). A future user location may be a specific location (e.g., restaurant address), or a more general location (e.g., a specific neighborhood or city). Each calendar entry may further indicate a time (e.g., date, start time, length, and/or time period) of the event.

In addition, the data that is obtained and/or analyzed may identify one or more upcoming and/or local events that the user is interested in and/or planning on attending. More particularly, an event may be identified based upon whether the user has clicked “Buy Ticket(s)” for the event, whether the user has explicitly selected “I'm interested” for the event, and/or whether the user has browsed to (e.g., clicked on) a web page or web site identifying or listing the event. Example events for which the user may purchase tickets may include sporting events, movies and/or theater productions.

In accordance with various embodiments, the user may define an event via an application implemented on a web site and/or installed on a mobile device such as a smartphone. More particularly, the user may define an event based upon one or more geographical criteria and/or time-based criteria. Such a user defined event may be referred to as a “bubble.” An event that is occurring at a future time may be referred to as a “future bubble.” The creation of a bubble may be interpreted by the system as interest of the user in the event defined by the bubble. In addition, if a user has explicitly indicated that they are interested in the bubble by selecting “I′m interested,” this may also be interpreted by the system as interest of the user in the event.

Furthermore, travel search data may be obtained and/or analyzed to identify an event that the user is interested in and/or planning on attending. More particularly, the travel search data may be obtained from the user's search and browsing history. The travel search data may include information pertaining to flight searches, hotel searches, and/or rental car searches. The travel search data may further identify one or more flights that the user has booked (e.g., purchased or reserved), one or more hotel reservations that the user has booked, and/or one or more rental car reservations that the user has booked. A flight that a user has booked may be identified by a date, time, flight number, and/or airport code. Similarly, a hotel reservation may be identified by a hotel name, address, location, check-in date, and/or check out date. A rental car reservation may be identified by a name of a rental car agency, a start time and/or return time.

A future location of the user may be identified based upon a path between two or more locations. More particularly, a future location may be any location within a path (i.e., route) between two or more locations. The two or more locations may include at least one event location. Alternatively, the locations may simply include the user's home and work locations. Travel may occur via a variety of means of travel. For example, travel may occur via car, mass transit (e.g., bus, train, etc.), and/or plane. Therefore, one or more potential paths may be identified based upon one or more possible means of travel and/or means of travel that are identified as the user's intended mode(s) of travel (e.g., via driving directions that are obtained, reservation, booking, calendar entry, etc.). Travel may also be inferred where two events are scheduled close in time (e.g., on the same date). For example, where the user has made a hotel reservation and reserved a car, it may be inferred that the user will travel between the rental car agency and the hotel. Therefore, one or more possible travel routes between these two “event” locations may be identified. Travel may also be inferred based upon mass transit search(es) performed by the user. Mass transit searches may identify one or more modes of transit, start time and/or end time specified in the transit search(es) and/or search results.

Weather searches may also be used to identify future location(s) of the user. More particularly, a weather search may include a search for a weather forecast for a particular geographical area (e.g., city). For example, the weather forecast may include an extended forecast over a number of days, an average forecast over a period of time (e.g., monthly average forecast), and/or a specific date search for a weather forecast or an average weather forecast over a specified time period.

Information pertaining to a set of one or more future locations may be stored in association with each of a plurality of users. The information may specifically identify each future location, which may be specified via coordinates, address, and/or region. In addition, the information may indicate a time associated with each future location. The time may include a date, as well as a start time, end time, and/or time range (e.g., up to 24 hours). In addition, a time (e.g., start and/or end time) may be specified in terms of date, as well as time of day. Additional event information may also be stored in association with each future location. For example, the event information may include an event title and/or type of event (e.g., sports event, restaurant reservation, hotel reservation, flight, car reservation, etc.).

Based upon predicted future user locations (FULs), it is possible to extrapolate the likely location of users at a particular point in time. Based upon this information, the system may track the likely locations of particular users at a particular point in time, as well as the likely identity of users that are present at a particular location at a given point in time. In this manner, it is possible to extrapolate the likely current location of users based upon predicted FULs.

Weighting of Predicted Future User Location

Each FUL of a user may be assigned a numerical value (e.g., weight) to indicate a probability that the user will attend an event at the FUL. As described above, the probability that a user will attend an event may be determined, at least in part, upon an amount of time prior to the event at the predicted FUL. Because a user can change or cancel future plans, the numerical value may be lower the farther out the time (e.g., date) of the event from the time (e.g., date) of signal collection identifying the FUL. The probability that a user will attend an event may also be determined, at least in part, upon a distance of the FUL from the user's NGA. Therefore, the numerical value may be greater (or lower) the farther the FUL from the NGA. The numerical value assigned to each FUL may also be calculated based upon one or more additional factors such as those described above.

Dynamic Refinements to Weighting of Predicted FUL

The system may determine whether the user ultimately went to a FUL. More particularly, the system may ascertain whether the user attended the event at the FUL. The system may then flag the FUL to indicate that the user attended the corresponding event. This determination may be used to further refine the weighting system. More particularly, by confirming attendance of events, the system may determine which data signals or data sources are most accurate (e.g., by associating a weight with the data signal or data source from which the event was identified). For example, where an event is a restaurant reservation, it may be determined that restaurant reservations are an accurate predictor of FUL 85 percent of the time. As another example, where the user simply indicates an interest an event, this may be a predictor of event attendance only 35 percent of the time.

The system may determine whether a user ultimately attended an event at a FUL by ascertaining the user's actual location. The user's actual location may be ascertained via a variety of mechanisms. For example, the system may determine whether the user checks in to a FUL via an application such as Foursquare, Messenger, or Bubbles. Such a check-in application may be implemented on a web site and/or a mobile device. Alternatively, a signal of the user's current location may be ascertained via a device such as a mobile device. For example, the mobile device may detect the user's location via a GPS or Internet Protocol (IP) Address. The user may also take explicit action to store their current location using an application on a device such as a mobile device.

The system may store FUL data for each of a plurality of users. In addition, the system may store the FUL data such that the FUL data is grouped according to time (e.g., date, time, and/or period of time) and/or location. For example, the system may store the data in a relational database such that the FUL data may be accessed by user, location, and/or time. From the FUL data, the system may ascertain the number of users predicted to be at a particular location at a particular time or over a particular time period. The information indicating a predicted number of users for a particular location may be used to determine the value of the location. For example, the information indicating the predicted number of users for a location may be used to assign a price to the location for purposes of auctioning the location. As another example, the information indicating the predicted number of users for a location may be used to assign a price to be charged for each “impression” of an application (or advertisement) provided to a user present at that location. For example, if the system has predicted with some certainty that 1400 people will be in New York City for a marathon, and that they will be staying within 2 blocks of 14^{th} and Broadway, then a higher auction price per location and/or higher price per impression may be charged than if the system predicted that only 2 people would be at the same location during the same time period. The predicted number of users for a location, price per location, and/or price per impression may be provided and/or otherwise made available to a Bidding Platform, which will be described in further detail below.

Bidding Platform

In accordance with various embodiments, a Bidding Platform may enable bids to be placed on any of a plurality of locations. These locations may be explicitly listed. A bid may therefore be placed on a location by selecting the corresponding location. Alternatively, locations may be defined as a result of the bidding process. For example, a bidder may define and select a particular geographic area using a map that is presented via a graphical user interface. In this manner, an advertiser or application developer/owner may place a bid on a particular location (e.g., geographic area).

A bidder may specify an application (or advertisement) in association with a bid through various mechanisms. For example, the bidder may identify a name of the application or a location at which the application can be obtained. As another example, the bidder may upload the application in association with the bid.

In addition, the system may provide information pertaining to locations of users tracked by the system via a graphical user interface to potential advertisers or application developers/owners via the Bidding Platform. More particularly, the information provided may include a number of users that are likely to be present at a particular location. This number may be provided as a single number over a period of time, or may be provided for incremental periods over time.

The Bidding Platform may further provide a price (or minimum price) associated with a particular location via a graphical user interface to potential advertisers or application developers/owners via the Bidding Platform. For example, the price may be a single price to be paid for the right to provide applications (or advertisements) to users at the location over a particular period of time. As another example, the price may be a price per impression to be charged each time an application (or advertisement) is provided to a user.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Network Architecture

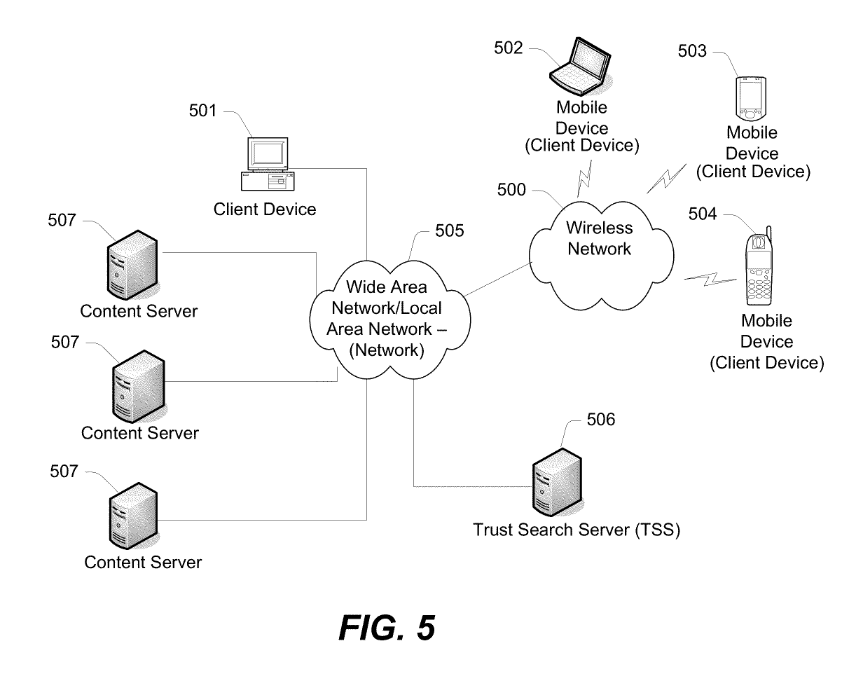

The disclosed embodiments may be implemented in any of a wide variety of computing contexts. FIG. 5 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 5, for example, includes a variety of networks, such as a LAN/WAN 505 and wireless network 500, a variety of devices, such as client devices 501-504, and a variety of servers such as content server(s) 507 and search server 506. The servers may also include an ad server (not shown). As shown in this example, the client devices 501-504 may include one or more mobile devices 502, 503, 504. Client device(s) 501-504 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

User locations may be identified and implemented to facilitate location-based application pop-ups according to the disclosed embodiments in some centralized manner. This is represented in FIG. 5 by content server(s) 507, which may correspond to multiple distributed devices and data store(s). The content server(s) 507 and/or corresponding data store(s) may store user account data and/or preferences, user locations and/or probable FULs, advertisements and/or application information (e.g., application identifier), applications, information pertaining to bids, and/or bubbles that have been generated.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VoIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

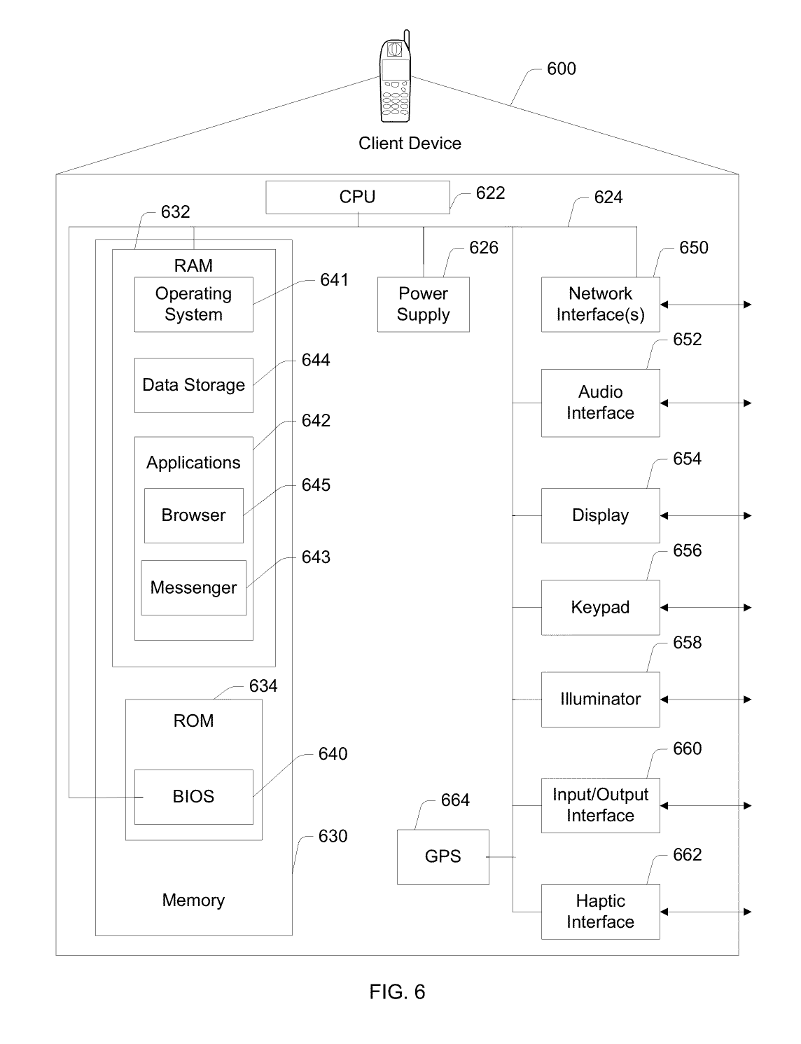

FIG. 6 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

As shown in this example, a client device 600 may include one or more central processing units (CPUs) 622, which may be coupled via connection 624 to a power supply 626 and a memory 630. The memory 630 may include random access memory (RAM) 632 and read only memory (ROM) 634. The ROM 634 may include a basic input/output system (BIOS) 640.

The RAM 632 may include an operating system 641. More particularly, a client device may include or may execute a variety of operating systems, including a personal computer operating system, such as a Windows, iOS or Linux, or a mobile operating system, such as iOS, Android, or Windows Mobile, or the like. The client device 600 may also include or may execute a variety of possible applications 642 (shown in RAM 632), such as a client software application such as messenger 643, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 600 may also include or execute an application to communicate content, such as, for example, textual content, multimedia content, or the like, which may be stored in data storage 644. A client device may also include or execute an application such as a browser 645 to perform a variety of possible tasks, such as browsing, searching, playing various forms of content, including locally stored or streamed video, or games (such as fantasy sports leagues).

The client device 600 may send or receive signals via one or more interface(s). As shown in this example, the client device 600 may include one or more network interfaces 650. The client device 600 may include an audio interface 652. In addition, the client device 600 may include a display 654 and an illuminator 658. The client device 600 may further include an Input/Output interface 660, as well as a Haptic Interface 662 supporting tactile feedback technology.

The client device 600 may vary in terms of capabilities or features. Claimed subject matter is intended to cover a wide range of potential variations. For example, a cell phone may include a keypad such 656 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 664 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

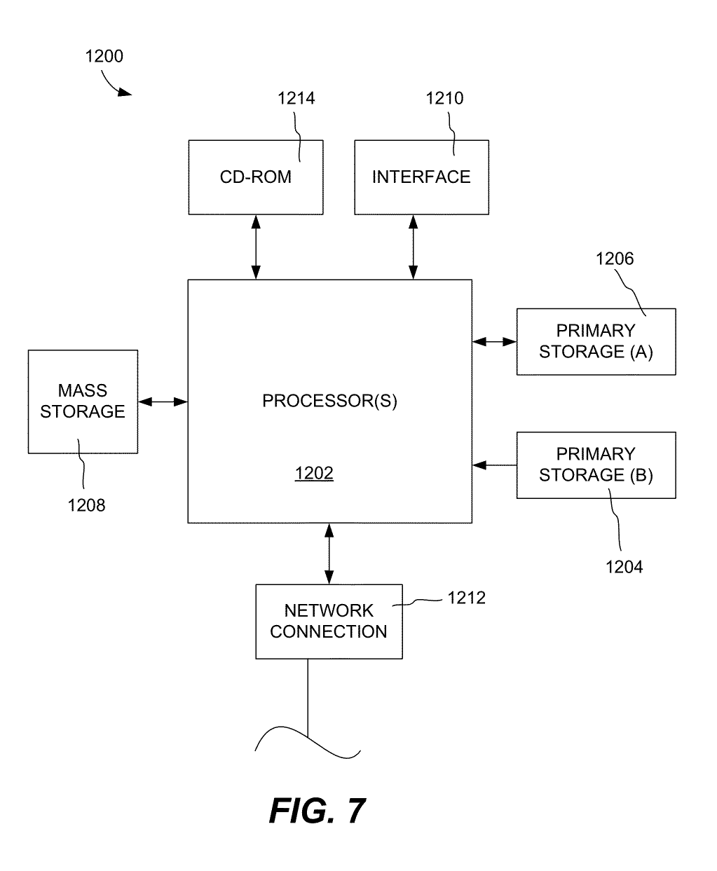

FIG. 7 illustrates a typical computer system that, when appropriately configured or designed, can serve as a system of this invention. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
identifying by a network device a location, the location being associated with a set of one or more applications;
ascertaining by the network device a set of one or more users that are present at the location; and
providing by the network device the set of one or more applications or one or more advertisements to the set of one or more users, each of the advertisements pertaining to a corresponding one of the set of one or more applications.

2. The method as recited in claim 1, further comprising:
auctioning the location such that the set of one or more applications are associated with the location prior to performing the identifying, ascertaining, and providing steps.

3. The method as recited in claim 2, wherein auctioning comprises:
auctioning an exclusive right pertaining to the set of one or more applications, the exclusive right being for the set of one or more applications or for advertisements pertaining to the set of one or more applications to be provided to users present at the location.

4. The method as recited in claim 2, wherein auctioning the location comprises:
obtaining a plurality of bids for the location, each of the plurality of bids pertaining to one of a plurality of applications; and
selecting a pre-defined number of the plurality of applications based, at least in part, upon the plurality of bids.

5. The method as recited in claim 1, wherein providing the set of one or more applications or one or more advertisements to the set of one or more users comprises:
providing the set of one or more applications or one or more advertisements to one of the set of one or more users when the one of the set of one or more users enters or arrives at the location.

6. The method as recited in claim 1, wherein providing the set of one or more applications or one or more advertisements to the set of one or more users comprises:
providing the set of one or more applications or one or more advertisements to one of the set of one or more users within a pre-determined period of time from when the one of the set of one or more users enters or arrives at the location.

7. The method as recited in claim 1, wherein the location comprises a geographical area, wherein providing the set of one or more applications or one or more advertisements to the set of one or more users comprises:
providing the set of one or more applications or one or more advertisements to one of the set of one or more users when the one of the set of one or more users enters the geographical area or within a pre-determined period of time from when the one of the set of users enters the geographical area.

8. A method, comprising:
identifying by a network device a location at which a user is present;
ascertaining by the network device a set of one or more applications associated with the location; and
providing by the network device the set of one or more applications or one or more advertisements to the user, each of the advertisements pertaining to a corresponding one of the set of one or more applications.

9. The method as recited in claim 8, wherein identifying by a network device a location at which a user is present comprises:
monitoring activities of the user to identify the location at which the user is present.

10. The method as recited in claim 8, wherein identifying by a network device a location at which a user is present comprises:
monitoring the location to identify users that are present at the location.

11. The method as recited in claim 8, further comprising:
auctioning the location such that the set of one or more applications are associated with the location prior to performing the identifying, ascertaining, and providing steps.

12. The method as recited in claim 11, wherein auctioning comprises:
auctioning an exclusive right pertaining to the set of one or more applications, the exclusive right being for the set of one or more applications or for advertisements pertaining to the set of one or more applications to be provided to users present at the location.

13. The method as recited in claim 11, wherein auctioning the location comprises:
obtaining a plurality of bids for the location, each of the plurality of bids pertaining to one of a plurality of applications; and
selecting a pre-defined number of the plurality of applications based, at least in part, upon the plurality of bids.

14. A method, comprising:
obtaining a plurality of bids for a location, each of the plurality of bids pertaining to one of a plurality of applications;
selecting a pre-defined number of the plurality of applications based, at least in part, upon the plurality of bids, such that a set of one or more of the plurality of applications is identified, wherein each of the plurality of bids pertains to an exclusive right for the set of one or more applications or one or more advertisements pertaining to the set of one or more applications to be provided to users present at the location; and
associating the set of one or more of the plurality of applications with the location.

15. The method as recited in claim 14, further comprising:
ascertaining a set of one or more users that are present at the location; and
automatically providing the set of one or more applications or one or more advertisements pertaining to the set of one or more applications to the set of one or more users.

16. The method as recited in claim 14, further comprising:
determining that a user is present at the location;
identifying the set of one or more applications associated with the location; and
providing the set of one or more applications or one or more advertisements pertaining to the set of one or more applications to the user.

17. The method as recited in claim 14, further comprising:
obtaining a second plurality of bids for a second location, each of the second plurality of bids pertaining to one of a second plurality of applications; and
selecting a pre-defined number of the second plurality of applications based, at least in part, upon the second plurality of bids, such that a second set of one or more of the second plurality of applications is generated, wherein each of the second plurality of bids pertains to an exclusive right for the second set of one or more applications or one or more advertisements pertaining to the second set of one or more applications to be provided to users present at the second location; and
associating the second set of one or more of the second plurality of applications with the second location

18. A non-transitory computer-readable medium, comprising:
instructions for identifying a location, the location being associated with a set of one or more applications;
instructions for ascertaining a set of one or more users that are present at the location; and
instructions for providing by the network device the set of one or more applications or one or more advertisements pertaining to the set of one or more applications to the set of one or more users, each of the advertisements pertaining to a corresponding one of the set of one or more applications.

19. The non-transitory computer-readable medium as recited in claim 18, wherein providing the set of one or more applications or one or more advertisements pertaining to the set of one or more applications to the set of one or more users is performed in response to ascertaining the set of one or more users that are present at the location.

20. The non-transitory computer-readable medium as recited in claim 18, wherein identifying a location comprises:
determining the location associated with the set of one or more applications.

21. An apparatus, comprising:
a processor; and
a memory, at least one of the processor or the memory being adapted for:
obtaining a plurality of bids for a location, each of the plurality of bids pertaining to one of a plurality of applications;
selecting a pre-defined number of the plurality of applications based, at least in part, upon the plurality of bids, such that a set of one or more of the plurality of applications is identified, wherein each of the plurality of bids pertains to an exclusive right for the set of one or more applications or one or more advertisements pertaining to the set of one or more applications to be provided to users present at the location; and
associating the set of one or more of the plurality of applications with the location.

22. The apparatus as recited in claim 21, at least one of the processor or the memory being further adapted for performing further steps, comprising:
ascertaining a set of one or more users that are present at the location; and
automatically providing the set of one or more applications or the one or more advertisements pertaining to the set of one or more applications to the set of one or more users.

23. The apparatus as recited in claim 21, at least one of the processor or the memory being further adapted for performing further steps, comprising:
determining that a user is present at the location;
identifying the set of one or more applications associated with the location; and
providing the set of one or more applications or one or more advertisements to the set of one or more users, each of the advertisements pertaining to a corresponding one of the set of one or more applications.

24. The apparatus as recited in claim 21, at least one of the processor or the memory being further adapted for performing further steps, comprising:
charging an amount for the associating, wherein the amount is based, at least in part, upon the pre-defined number of the plurality of applications.
